(19) United States
(12) Patent Application Publication
(10) Pub. No.: US 2010/0241413 A1
(43) Pub. Date: Sep. 23, 2010

(54) METHOD AND SYSTEM FOR MODELING AN LDMOS TRANSISTOR

(75) Inventors: Yong Liu, Murphy, TX (US); Keith R. Green, Prosper, TX (US); Sameer Pendharkar, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/406,423

(22) Filed: Mar. 18, 2009

(51) Int. Cl. G06F 17/50

(52) U.S. Cl. 703/14

(57) ABSTRACT

A processor with a computer program product embodied thereon for modeling an LDMOS transistor having a drift region is provided. Characteristic behavior of a CMOS transistor with its body coupled to its source is generated, and characteristic behavior of a resistor is generated, where the resistor is coupled to the drain of the CMOS transistor. Then to account for impact ionization, an impact ionization current for electrons in the drift region an impact ionization current for holes in the drift region are calculated.

### TECHNICAL FIELD

The invention relates generally to transistor modeling and, more particularly, to modeling a Laterally Diffused Metal Oxide Semiconductor (LDMOS).

### BACKGROUND

Over the years, modeling transistor behavior has become common practice. There are numerous software packages that are now commercial available to do so, and these models are used to development integrated circuits or ICs for commercial sale. As a result, the accuracy of these models is important because inaccurate models can adversely affect development and increase the development costs. Some examples of prior art models are: U.S. Pat. No. 7,395.192; U.S. Pat. No. 6,314,390; U.S. Pat. No. 6,901,570; U.S. Pat. No. 7,093,214; U.S. Pat. No. 7,110,930; U.S. Pat. No. 7,246,051; U.S. Pat. No. 7,292,968; U.S. Pat. No. 7,313,770; U.S. Pat. No. 7,337,420; U.S. Pat. No. 7,343,571; and Hower et al., “A Rugged LDMOS for LCB5 Technology,” Proceedings of the 17^{th} Intl. Symposium on Power Semiconductor Devices & IC's, May 23-26, 2005.

Now turning to FIG. 1 of the drawings, a graph depicting drain current I_{D} versus drain-source voltage V_{DS} of a conventional Complementary Metal Oxide Semiconductor (CMOS) transistor is shown. As can be seen, the CMOS transistor has a linear region for every current level. For lower drain currents I_{D}, the drain current I_{D} remains relatively constant once the CMOS transistor becomes saturated over a wide range of drain-source voltages V_{DS}. However, for larger drain current I_{D}, the drain current I_{D} remains relatively constant over a narrow range of drain-source voltages V_{DS} once the CMOS transistor becomes saturated and then increases with a corresponding increase in drain-source voltage V_{DS} outside of the narrow region.

Turning to FIG. 2 of the drawings, a convention n-type CMOS or NMOS transistor 200 that generally exhibits the behavior of depicted in FIG. 1 is shown. Transistor 200 is generally comprised of a substrate 202, which is doped with a p-type material (such as boron), that has a number of elements or regions formed thereon or therein. As shown, drain and source regions 210 and 212 are formed in the substrate 202 and generally doped with an n-type material (such as arsenic). Located within the substrate 202 in a region between the drain and source regions 210 and 212 is a channel 208, and formed on the substrate over the channel 208 and portions of the drain and source regions 210 and 212 is a insulator or gate oxide layer (made of, for example, silicon dioxide). A gate electrode 206 (which is generally comprised of polysilicon, for example) can then be formed on the insulator 204. Additionally, body region 214 can also be formed in the substrate 202 (which is generally doped with a p-type material).

Referring now to FIG. 3, of the drawings a conventional p-type CMOS or PMOS transistor 300 that generally exhibits the behavior depicted in FIG. 1 is shown. As with the transistor 200, transistor also includes a drain region 306, a source region 310 and a body region 304 formed in substrate 202, and an insulator 204 and gate electrode 206 formed on the substrate 202. However, a difference between the transistor is that a n-type well 302 is formed within the substrate 202, and the a drain region 306, a source region 310, and a body region 304 are formed within well 302 and having a doping that is inverse to the drain region 210, source region 212, and body region 214.

However, the behaviors and characteristics of these conventional devices are different from LDMOS transistor.

### SUMMARY

A preferred embodiment of the present invention, accordingly, provides a processor with a computer program product embodied thereon for modeling an LDMOS transistor having a drift region. The computer program product comprises computer code for generating characteristic behavior of a CMOS transistor with its body coupled to its source; computer code for generating characteristic behavior of a resistor, wherein the resistor is coupled to the drain of the CMOS transistor; computer code for calculating an impact ionization current for electrons in the drift region; and computer code for calculating an impact ionization current for holes in the drift region.

In accordance with a preferred embodiment of the present invention, the resistor has a resistivity of about 2700 Ω/sq.

In accordance with a preferred embodiment of the present invention, the computer code for generating characteristic behavior of the CMOS transistor further comprises generating the behavior of a transistor having a substrate of a first type; a first region of a second type formed in the substrate, wherein the first region corresponds to the source of the CMOS transistor; a second region of a second type formed in the substrate, wherein the second region corresponds to the drain of the CMOS transistor; a third region formed in the substrate that corresponds to the body of the CMOS transistor; a channel within the substrate, wherein the channel is located between the first and the second regions; an insulator formed on at least a portion of the substrate, wherein the insulator extends over at least a portion of each of the first and second regions and extends over at least a portion of the channel; and a gate electrode formed on at least a portion of the insulator.

In accordance with a preferred embodiment of the present invention, the impact ionization current for the electrons is

Iᵢᵢ=C₁*I_{SOURCE}*E* exp(−C₂/E),

where C₁ and C₂ are model fitting parameters, I_{SOURCE} is the source current, and E is the electric field in the drift region.

In accordance with a preferred embodiment of the present invention, the impact ionization current for the holes is

Iᵢᵢ=C₁*I_{SOURCE}*E* exp(−C₂/E),

where C₁ and C₂ are model fitting parameters, I_{SOURCE} is the source current, and E is the electric field in the drift region.

In accordance with a preferred embodiment of the present invention, a system for modeling an LDMOS transistor comprising a processor with a computer program product embodied thereon is provided. The computer program product includes a database having a CMOS transistor model, a resistor model, and a current source model; and an execution module that predicts the behavior of the LDMOS transistor with an LDMOS model, wherein the LDMOS model includes a CMOS transistor having behavior that corresponds to the CMOS transistor model; a resistor that is coupled to the drain of the CMOS transistor, where the resistor has behavior that corresponds to the resistor model; a first current that is coupled to the drain of the CMOS transistor in parallel to the resistor, wherein the first current source has behavior that corresponds to the current source model; and a second current source that is coupled to the resistor, the first current source and the body of the CMOS transistor, wherein the second current source has behavior that corresponds to the current source model.

In accordance with a preferred embodiment of the present invention, the system further comprises a user interface that is coupled to the processor.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a graph depicting the drain current versus the source-drain voltage of a convention CMOS transistor;

FIG. 2 is a cross-sectional view of a convention NMOS transistor;

FIG. 3 is a cross-sectional view of a convention PMOS transistor;

FIG. 4 is a graph depicting the drain current versus the source-drain voltage of an LDMOS transistor;

FIGS. 5 and 6 are example cross-sectional views of an LDMOS transistor;

FIG. 7 is a block diagram of an inaccurate model for an LDMOS transistor;

FIG. 8 is a block diagram of a model of an LDMOS transistor in accordance with a preferred embodiment of the present invention; and

FIG. 9 is a block diagram of a system that is adapted to have the model of FIG. 8 embodied thereon.

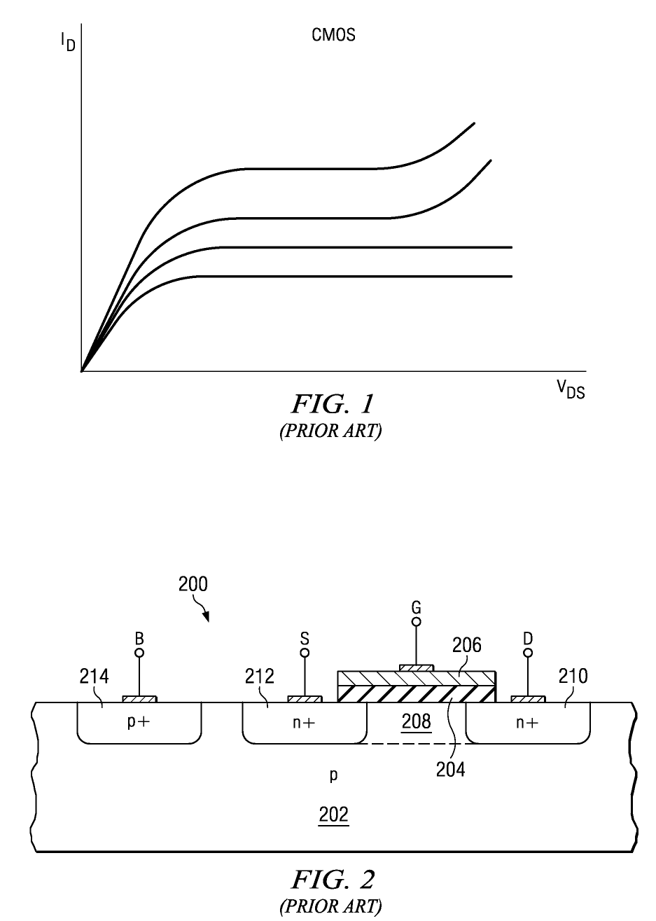

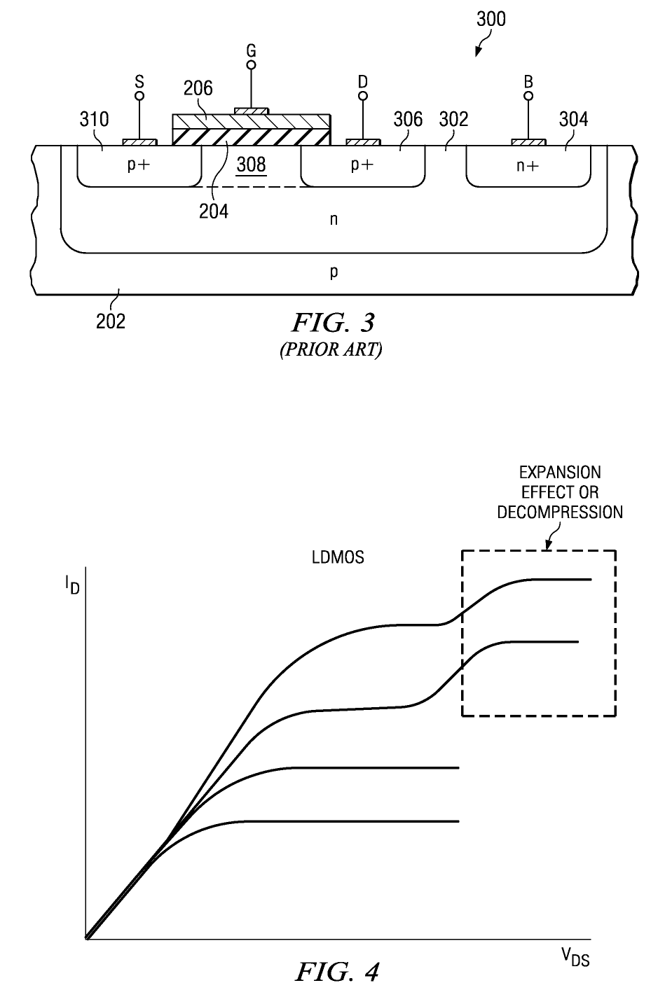

### DETAILED DESCRIPTION

Refer now to the drawings wherein depicted elements are, for the sake of clarity, not necessarily shown to scale and wherein like or similar elements are designated by the same reference numeral through the several views.

Turning to FIG. 4 of the drawings, a graph depicting the drain current I_{D} versus drain-source voltage V_{DS} of an LDMOS transistor is shown. Similar to conventional CMOS transistors, the LDMOS transistor has a linear region for every current level. For lower drain currents I_{D}, the drain current I_{D} remains relatively constant once the CMOS transistor becomes saturated over a wide range of drain-source voltages V_{DS}. However, for larger drain current I_{D}, the drain current I_{D} remains relatively constant over a narrow range of drain-source voltages V_{DS} once the LDMOS transistor becomes saturated and then increases with a corresponding increase in drain-source voltage V_{DS} outside of the narrow region, similar to conventional CMOS transistors. One difference, though, is that the larger currents I_{D} again plateaus for large drain-source voltages V_{DS} due to a so-called expansion effect or decompression.

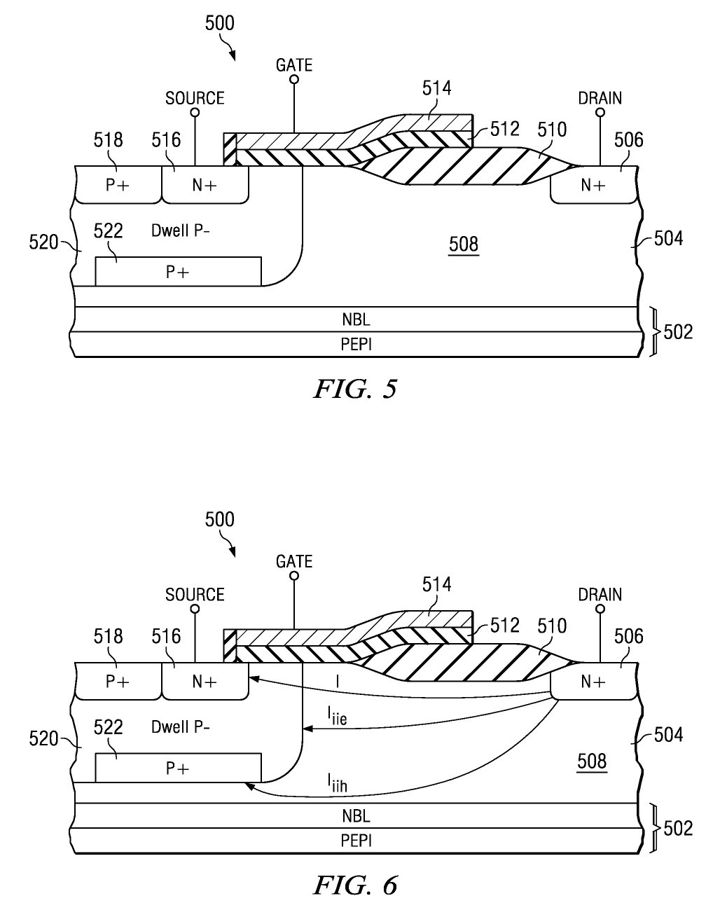

A reason for the different behavior of the LDMOS transistors versus conventional CMOS transistors is the difference in geometry. An example of the geometry and process for making an LDMOS transistor is described in U.S. Pat. No. 7,268,045, which is hereby incorporated by reference for all purpose, and an example for an LDMOS transistor is shown in FIGS. 5 and 6.

Turning to FIGS. 5 and 6, an example of an LDMOS transistor 500 is shown. The LDMOS transistor 500 generally comprises a substrate 502, a tank doped with an n-type material (such as arsenic) or N-tank 504, a drain region 506, a drift region 508, a filed oxide layer of FOX 510, a gate dielectric layer 512, gate electrode 514, a source electrode 516, a region 518, a Dwell 520, and a burred body 522. As can be seen from FIGS. 5 and 6, a difference between the CMOS transistors 200 and 300 and the LDMOS 500 is the Dwell 520 (which is lightly doped with a p-type material, such as boron) that includes the buried body 522 (which is a more heavily doped with a p-type material). It is the use of this buried body 522 that can contribute to the expansion effect or decompression of the LDMOS transistor 500.

In operation, a current and voltage can be applied to the gate electrode 514 to allow conduction between the drain region 506 and the source region 516. Typically, a current I flows through the drift region between regions 506 and 508. Additionally, there is an impact ionization current that exists within the drift region 508. This ionization current is generally comprised of an impact ionization current Iiie attributed to electrons in the drift region 508 and an impact ionization current Iiih attributed to holes in the drift region 508. Generally, the impact ionization current can be calculated as follows:

Iᵢᵢ=C₁*I_{SOURCE}*E* exp(−C₂/E), (1)

where C₁ and C₂ are model fitting parameters, I is the source current, and E is the electric field in the drift region 508.

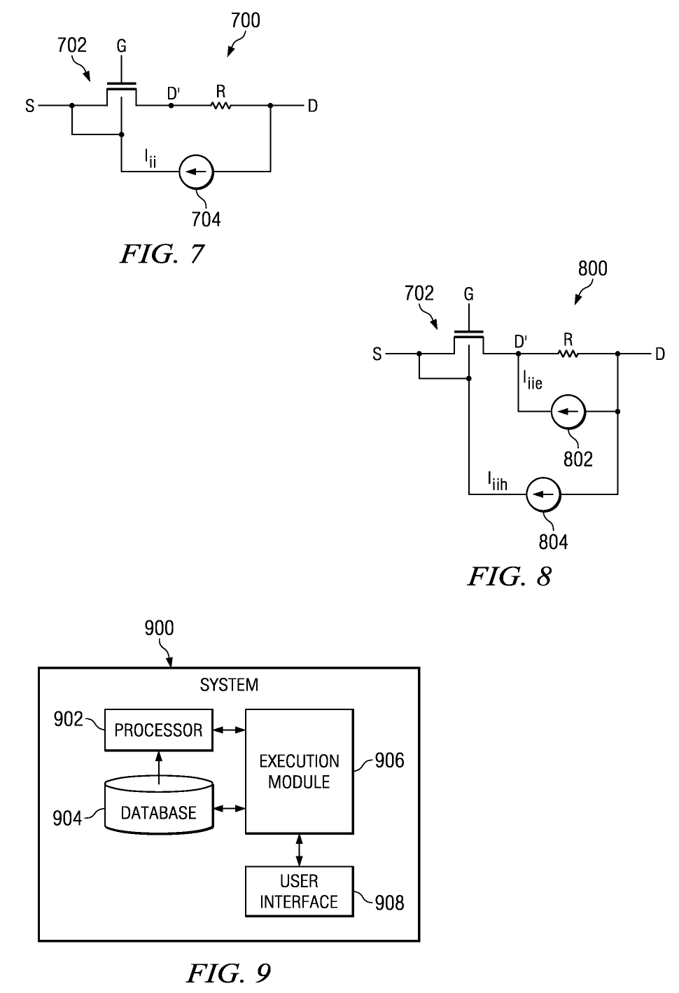

Previously, the effects of the impaction ionization currents Iᵢᵢₑ and Iᵢᵢₕ attributed to electrons and holes in the drift region 508 were not appreciated, which resulted in the transistor model shown in FIG. 7. Referring to FIG. 7, an inaccurate model for the LDMOS transistor 700 is shown. This model 700 generally comprises a model or computer code for a conventional CMOS transistor (such as CMOS transistors 200 and 300), computer code for a resistor R, and computer code for a current source 704. To model the behavior of an LDMOS transistor, resistor R operated as the impedance for drift region 508, while current source operated as the impact ionization current Iii. However, because this model 700 does not appreciate the impaction ionization currents Iᵢᵢₑ and Iᵢᵢₕ attributed to electrons and holes in the drift region 508, the model would not accurately prediction the expansion effect.

To account for the impaction ionization currents Iᵢᵢₑ and Iᵢᵢₕ attributed to electrons and holes in the drift region 508, model 800 of FIG. 8 has been developed. Similar to model 700, model 800 includes computer code for a typical or conventional CMOS transistor 702 and computer code for a resistor R. Preferably, the resistor R has a resistivity of about 2700 Ω/sq., so that resistor R can be varied depending on the geometry of the LDMOS transistor. One difference, though, is that this model 800 includes computer code two current sources 802 and 804, where the currents Iᵢᵢₑ and Iᵢᵢₕ can be calculated using equation (1) above. Preferably, current source 802 represents the impaction ionization current Iᵢᵢₑ attributed to electrons in the drift region 508, while current source 508 represents impaction ionization current Iᵢᵢₕ attributed to holes in the drift region 508. Thus, model 800 is able to accurate predict and model the expansion effect for an LDMOS transistor.

In order to generate the predicted results and use the models, a system 900, as shown in FIG. 9, is employed. Preferably, this system 900 is a personal computer, but can be a number of other electronic data processing systems can be employed. System 900 generally comprises a processor 902, an execution module 906, a database 904, and a user interface 908. In operation, the user can interact through the user interface 906 with an execution module 906, which is preferably a computer program that is embodied on the processor 902, to construct and operate the model 800 using computer code for the conventional CMOS transistor 702, current sources 802 and 804, and resistor R, which are preferably stored in the database 904. Thus, the user is able to use the system 900 as a design tool to develop semiconductors, which can accurately predict the behavior of LDMOS transistors, such as LDMOS transistor 500.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1. A processor with a computer program product embodied thereon for modeling an LDMOS transistor having a drift region, the computer program product comprising:
computer code for generating characteristic behavior of a CMOS transistor with its body coupled to its source;
computer code for generating characteristic behavior of a resistor, wherein the resistor is coupled to the drain of the CMOS transistor;
computer code for calculating an impact ionization current for electrons in the drift region; and
computer code for calculating an impact ionization current for holes in the drift region.

2. The computer program product of claim 1, wherein the resistor has a resistivity of about 2700 Ω/sq.

3. The computer program product of claim 1, wherein computer code for generating characteristic behavior of the CMOS transistor further comprises generating the behavior of a transistor having:
a substrate of a first type;
a first region of a second type formed in the substrate, wherein the first region corresponds to the source of the CMOS transistor;
a second region of a second type formed in the substrate, wherein the second region corresponds to the drain of the CMOS transistor;
a third region formed in the substrate that corresponds to the body of the CMOS transistor;
a channel within the substrate, wherein the channel is located between the first and the second regions;
an insulator formed on at least a portion of the substrate, wherein the insulator extends over at least a portion of each of the first and second regions and extends over at least a portion of the channel; and
a gate electrode formed on at least a portion of the insulator.

4. The computer program product of claim 1, wherein the impact ionization current for the electrons is
Iᵢᵢ=C₁*I_{SOURCE}*E* exp(−C₂/E),
where C₁ and C₂ are model fitting parameters, I_{SOURCE} is the source current, and E is the electric field in the drift region.

5. The computer program product of claim 1, wherein the impact ionization current for the holes is
Iᵢᵢ=C₁*I_{SOURCE}*E* exp(−C₂/E),
where C₁ and C₂ are model fitting parameters, I_{SOURCE} is the source current, and E is the electric field in the drift region.

6. A system for modeling an LDMOS transistor comprising a processor with a computer program product embodied thereon, wherein the computer program product includes:
a database having a CMOS transistor model, a resistor model, and a current source model; and
an execution module that predicts the behavior of the LDMOS transistor with an LDMOS model, wherein the LDMOS model includes:
a CMOS transistor having behavior that corresponds to the CMOS transistor model;
a resistor that is coupled to the drain of the CMOS transistor, where the resistor has behavior that corresponds to the resistor model;
a first current that is coupled to the drain of the CMOS transistor in parallel to the resistor, wherein the first current source has behavior that corresponds to the current source model; and
a second current source that is coupled to the resistor, the first current source and the body of the CMOS transistor, wherein the second current source has behavior that corresponds to the current source model.

7. The system of claim 6, wherein the system further comprises a user interface that is coupled to the processor.

8. The system of claim 6, wherein the resistor has a resistivity of about 2700 Ω/sq.

9. The system of claim 6, wherein the CMOS transistor further comprises a transistor having:
a substrate of a first type;
a first region of a second type formed in the substrate, wherein the first region corresponds to the source of the typical CMOS transistor;
a second region of a second type formed in the substrate, wherein the second region corresponds to the drain of the typical CMOS transistor;
a third region formed in the substrate that corresponds to the bode of the typical CMOS transistor;
a channel within the substrate, wherein the channel is located between the first and the second regions;
an insulator formed on at least a portion of the substrate, wherein the insulator extends over at least a portion of each of the first and second regions and extends over at least a portion of the channel; and
a gate electrode formed on at least a portion of the insulator.

10. The computer program product of claim 6, wherein the impact ionization current for the electrons is
Iᵢᵢ=C₁*I_{SOURCE}*E* exp(−C₂/E),
where C₁ and C₂ are model fitting parameters, I_{SOURCE} is the source current, and E is the electric field in the drift region.

11. The computer program product of claim 6, wherein the impact ionization current for the holes is
Iᵢᵢ=C₁*I_{SOURCE}*E* exp(−C₂/E),
where C₁ and C₂ are model fitting parameters, I_{SOURCE} is the source current, and E is the electric field in the drift region.
